(19) United States
(12) Patent Application Publication
(10) Pub. No.: US 2021/0088547 A1
(43) Pub. Date: Mar. 25, 2021

(54) Method and Device for Operating an Inertial Sensor Unit for a Vehicle

(71) Applicant: Robert Bosch GmbH, Stuttgart (DE)

(72) Inventor: Marlon Ramon Ewert, Untergruppenbach (DE)

(21) Appl. No.: 16/954,805

(22) PCT Filed: Dec. 6, 2018
(86) PCT No.: PCT/EP2018/083754

§ 371 Date: Jun. 17, 2020

(30) Foreign Application Priority Data
Dec. 18, 2017 (DE) 10 2017 223 001.0

(51) Int. Cl. G01P 15/08; G01B 21/22; G01P 3/00

(52) U.S. Cl. CPC G01P 15/08; G01P 3/00; G01B 21/22

(57) ABSTRACT

The disclosure relates to a method for operating an inertial sensor unit for a vehicle, comprising the following steps: a. detecting inertial sensor data, driving direction data and/or steering angle data and/or wheel rotational speeds during the journey of the vehicle; b. determining a correction matrix for the inertial sensor data subject to the detected driving direction data and/or steering angle data; c. determining a transformation matrix for the inertial sensor data for a target coordinate system subject to the driving direction data and/or steering angle data; d. transforming the inertial sensor data by means of the correction matrix and/or transformation matrix; e. outputting the transformed inertial sensor data.

### PRIOR ART

Inertial sensor units record inertial sensor data, that is to say acceleration data and rate of rotation data. Inertial sensor units may in principle record the inertial sensor data in any direction in space. The inertial sensor data are typically applied in the three traditional directions in space in accordance with the three finger rule or the right hand rule. This gives the coordinate system of the inertial sensor.

If an inertial sensor unit is installed in a vehicle, there are many reasons why the coordinate system does not correspond to the coordinate system of the vehicle or to the target coordinate systems of the other vehicle systems.

It is therefore not uncommon to transform the inertial sensor data into the desired target coordinate system or systems by way of predefined rules.

If this rule is taken into consideration in the processing software of the inertial sensor unit at the time of development, this may result in errors or uncertainties that are in some cases able to be overcome only with difficulty.

### DISCLOSURE OF THE INVENTION

Against this background, the present invention proposes a method for operating an inertial sensor unit for a vehicle.

The method comprises the following steps:
a) recording inertial sensor data, direction of travel data or steering angle data or wheel rotational speeds during the travel of the vehicle;
b) determining a correction matrix for the inertial sensor data depending on the direction of travel data or steering angle data;
c) determining a transformation matrix for the inertia sensor data for a target coordinate system depending on the direction of travel data or steering angle data;
d) transforming the inertial sensor data by way of the correction matrix or the transformation matrix;
e) outputting the transformed inertial sensor data.

Direction of travel data are in the present case understood to mean data that comprise information about the direction of travel of the vehicle.

Steering angle data are in the present case understood to mean data that comprise information about the steering angle or the travel on a bend of the vehicle.

It is possible to derive the yaw rate from the wheel rotational speeds together with the steering angle.

A correction matrix is a rule for transforming inertial sensor data for the purpose of compensating installation tolerances of the inertial sensor system when it is installed in the vehicle.

A transformation matrix is a rule for transforming inertial sensor data from the coordinate system of the inertial sensor unit into a target coordinate system. Such a target coordinate system may in this case comprise a 180° rotation of the coordinate system of the inertial sensor unit. The change of direction of a direction in space is also or additionally conceivable, such that an axis that would be given positive values according to the three finger rule is then given negative values. The transformation matrix may likewise comprise scales that deviate from the original coordinate system.

The advantage of the method of the present invention is that of attempting to achieve a situation whereby a predefined rule for transforming the inertial sensor data is able to be dispensed with.

Thus, for example, in the step of determining the transformation matrix, the transformation matrix may be determined by comparing the recorded inertial sensor data, direction of travel data or steering angle data with the target coordinate system.

To this end, the target coordinate system may be stored in a memory, for example non-volatile memory, that is assigned to the inertial sensor unit.

The memory is assigned to the inertial sensor unit, that is to say that the inertial sensor unit is able to access the memory. The memory itself does not necessarily have to be part of the inertial sensor unit for this purpose. Thus, for example, the memory may be part of a vehicle system to which the inertial sensor unit is coupled.

The transformation matrix is then determined by way of the method of the present invention. Design and programming errors are thus able to be prevented.

Furthermore, it is not necessary to develop an explicit rule for each predefined target coordinate system, but rather it is enough to predefine or set the desired target coordinate system. The transformation matrix is then determined automatically by way of the method according to the present invention.

The operation of an inertial sensor unit or of units that process data of an inertial sensor unit, such as for example a highly accurate position determination device, is therefore configured in a more reliable manner.

According to one embodiment of the method according to the present invention, the step of determining a correction matrix or the step of determining a transformation matrix takes place only in a learning phase of the operation of the inertial sensor unit.

For an inertial sensor unit, there may be provision for the initial service life following installation of the inertial sensor unit in a vehicle to be a learning phase. At this time, the inertial sensor unit is configured and fine-tuned substantially automatically. Settings that are able to be changed during the learning phase are fixed after the end of the learning phase and are not able to be changed, or are able to be changed only with considerable difficulty.

It would additionally be conceivable for a change to be able to take place only in the scope of maintenance or exchange work. A change or an erasure performed by way of a diagnostic device, for example by way of a diagnostic plug, would be conceivable in this case.

For the learning phase, it is possible to define a particular time or a particular distance that the vehicle has to have covered. A typical value is in this case 20 km. Depending on the difficulty and the scope of the configuration tasks, the time or the distance may be adjusted. It is clear that there is a balance between precision of the configuration and full use of the inertial sensor unit or the further vehicle systems connected or coupled to the inertial sensor unit. It is conceivable for the inertial sensor unit or the further vehicle systems to provide a restricted functional scope during the learning phase.

According to one embodiment of the method according to the present invention, the method comprises the additional combination step in which, in the step, the correction matrix and the transormation matrix are combined to form a correction transformation matrix.

According to this embodiment, in the transformation step, the inertial sensor data are then transformed by way of the combined correction transformation matrix.

The advantage of this embodiment is that, instead of a plurality of transformations, specifically first of all a correction transformation and then the transformation into the target coordinate system, or vice versa, a single transformation by way of the correction transformation matrix is sufficient. This saves on computing resources and may thus contribute to speeding up the method.

It is furthermore possible to save on memory space, since it would be sufficient only to store the correction transformation matrix in the non-volatile memory of the inertial sensor unit.

It is advantageous for the combination step to take place at the end of the learning phase.

Adjustments to the correction matrix may in particular be made continuously during the learning phase. It is accordingly advantageous to combine the correction matrix and the transformation matrix only at the end of the learning phase.

According to one embodiment of the method according to the present invention, the correction transformation matrix is stored in a non-volatile memory that is assigned to the inertial sensor unit.

This embodiment entails the advantage that the correction transformation matrix does not have to be recreated at each restart of the inertial sensor unit, but rather is present in a memory in retrievable form.

The memory is assigned to the inertial sensor unit, that is to say that the inertial sensor unit is able to access the memory. The memory itself does not necessarily have to be part of the inertial sensor unit for this purpose. Thus, for example, the memory may be part of a vehicle system to which the inertial sensor unit is coupled.

It is additionally conceivable to read the correction transformation matrix from the memory for test or verification purposes.

It furthermore conceivable for the correction transformation matrix to be changed or erased for diagnostic or maintenance purposes.

It is advantageous for the storage to take place at the end of the learning phase.

As an alternative, it is conceivable for the storage to take place continuously during the learning phase and for further storage to be prohibited or prevented at the end of the learning phase, for example by applying what is known as a lock to the memory.

Adjustments to the correction transformation matrix may in particular be made continuously during the learning phase. It is accordingly advantageous to store the correction transformation matrix in the non-volatile memory only at the end of the learning phase.

According to one embodiment of the method according to the present invention, the correction matrix is stored in a non-volatile memory of the inertial sensor unit.

This embodiment entails the advantage that the correction matrix does not have to be recreated at each restart of the inertial sensor unit, but rather is present in a memory in retrievable form.

It is advantageous for the storage to take place at the end of the learning phase.

As an alternative, it is conceivable for the storage to take place continuously during the learning phase and for further storage to be prohibited or prevented at the end of the learning phase, for example by applying what is known as a lock to the memory.

Adjustments to the correction matrix may in particular be made continuously during the learning phase. It is accordingly advantageous to store the correction matrix in the non-volatile memory only at the end of the learning phase.

According to one embodiment of the method according to the present invention, the transformation matrix is stored in a non-volatile memory of the inertial sensor unit.

This embodiment entails the advantage that the transformation matrix does not have to be recreated at each restart of the inertial sensor unit, but rather is present in a memory in retrievable form.

It is advantageous for the storage to take place at the end of the learning phase.

Adjustments to the transformation matrix may also be made continuously during the learning phase. It is accordingly advantageous to store the transformation matrix in the non-volatile memory only at the end of the learning phase.

According to one embodiment of the method according to the present invention, the method has the additional step of scaling the inertial sensor data by way of a scaling matrix.

It is in this case conceivable to incorporate a change in resolution of the inertial sensorinto data the transformations. It is furthermore conceivable for the scaling matrix to be incorporated into the combined correction transformation matrix, as a result of which no further conversion, that is to say data conversion, is required for the output in the step of outputting onto a data bus.

The processing steps from the recording up to the outputting are thereby able to be reduced, and this in particular saves on computing resources and time.

A further aspect of the present invention is a computer program that is configured so as to execute all of the steps of the method according to the present invention.

A further aspect of the present invention is a machine-readable storage medium on which the computer program according to the present invention is stored.

A further aspect of the present invention is an electronic control unit that is configured so as to execute all of the steps of the method according to the present invention.

One embodiment of the electronic control unit according to the present invention has at least one non-volatile memory for storing a correction matrix or a transformation matrix or a correction transformation matrix.

Details and embodiments of the invention are explained in more detail below with reference to a FIGURE, in which:

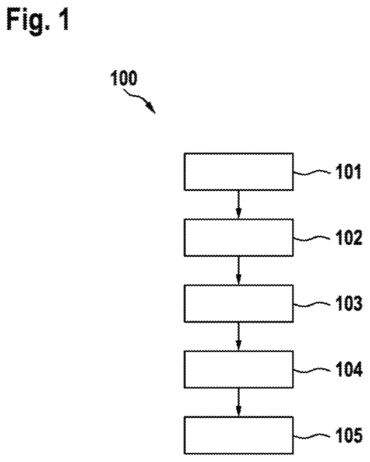

FIG. 1 shows a flowchart of the method according to the present invention.

FIG. 1 shows a flowchart of the method 100 according to the present invention.

The method 100 takes place during travel of a vehicle having an inertial sensor unit according to the present invention.

In step 101, inertial sensor data and direction of travel data or steering angle data and wheel rotational speeds are recorded. Direction of travel data or steering angle data may be recorded using corresponding sensors of the vehicle. In this case, it is also conceivable for example for direction or travel data to be recorded via the setting of the gear lever or the setting of the drivetrain, in particular the transmission, of the vehicle.

In step 102, a correction matrix for the inertial sensor data is determined depending on the recorded direction of travel data or steering angle data. The correction matrix may serve to correct small angle errors that arise due to installation tolerances of the inertial sensor unit in the vehicle or as part of further vehicle systems in these vehicle systems. In particular in cases in whlch the inertial sensor unit is part of a highly accurate position determination vehicle system, it is advantageous for even very small angle errors to be corrected as early as possible in the signal chain.

The determination is in this case based on comparing the recorded inertial sensor data, direction of travel data and steering angle data. A correction by way of setpoint and actual comparisons is conceivable in this case.

In step 103, a transformation matrix for a target coordinate system is determined depending on the direction of travel data or steering angle data or when rotational speeds.

This step may take place using two techniques.

Firstly, the coordinate system of the inertial sensor unit and the target coordinate system may be compared on the basis of the inertial sensor data, the direction of travel data or the steering angle data or the wheel rotational speeds. This may in this case initially be a rough determination, for example pertaining as to whether the target coordinate system is set up in accordance with the three finger rule or whether the coordinate system of the inertial sensor unit, when installed in the vehicle, corresponds to the coordinate system of the vehicle (sign check).

For this determination technique, it is useful for the target coordinate system to be present, for example stored in a memory unit assigned to the inertial sensor unit for example a non-volatile memory.

The memory is assigned to the inertial sensor unit, that is to say that the inertial sensor unit is able to access the memory. The memory itself does not necessarily have to be part of the inertial sensor unit. The memory may thus for example be part of a vehicle system to whlch the inertial sensor unit is coupled.

Secondly, it is possible to perform fine-tuning, for example when the target coordinate system is not just rotated by multiples of 90° with respect to the coordinate systems of the inertial sensor unit or individual axes of the coordinate systems have their positive values in different directions, even if the transformations turn out to be more complex.

In the same way as for the first technique, it is also useful for the target coordinate system to be present for the second technique.

In step 104, the inertial sensor data are transformed by way of the correction matrix or the transformation matrix.

The application is also variable in this case. By way of example, it is conceivable for uncorrected and untransformed inertial sensor data to be just as necessary as corrected and transformed inertial sensor data for coupled vehicle systems performing further processing. It is likewise conceivable for a plurality of transformation matrices to be present depending on the coupled vehicle system performing further processing. A plurality of transformations with different transformation matrices take place in order to compensate installation or temperature tolerances after the inertial sensor data have been corrected.

In step 105, the transformed inertial sensor data are output. The inertial sensor data may in this case be output via a vehicle communication system, such as for example a bus system, such as for example CAN, FlexRay or Ethernet. Outputting via wireless communication means or channels is also conceivable.

1. A method for operating an inertial sensor unit for a vehicle, the method comprising:
a) recording inertial sensor data and at least one of direction of travel data, steering angle data, and wheel rotational speeds during travel of the vehicle;
b) determining a correction matrix for the inertial sensor data based on at least one of the direction of travel data and the steering angle data;
c) determining a transformation matrix for the inertial sensor data for a target coordinate system based on at least one of the direction of travel data and the steering angle data;
d) transforming the inertial sensor data using at least one of the correction matrix and the transformation matrix; and
e) outputting the transformed inertial sensor data.

2. The method as claimed in claim 1, wherein at least one of:
the determining the correction matrix takes place only in a learning phase of an operation of the inertial sensor unit; and
the determining the transformation matrix takes place only in the learning phase of the operation of the inertial sensor unit.

3. The method as claimed in claim 2, further comprising:
combining the correction matrix and the transformation matrix to form a correction transformation matrix at the end of the learning phase,
wherein the transforming the inertial sensor data comprises transforming the inertial sensor data using the correction transformation matrix.

4. The method as claimed in claim 3, further comprising:
storing the correction transformation matrix in a non-volatile memory of the inertial sensor unit at the end of the learning phase.

5. The method as claimed in claim 2, further comprising:
storing at least one of the correction matrix and the transformation matrix in a non-volatile memory of the inertial sensor unit at the end of the learning phase.

6. The method as claimed in claim 1, further comprising:
scaling the inertial sensor data using a scaling matrix for the outputting of the inertial sensor data.

7. The method as claimed in claim 1, wherein the method is performed by a computer program.

8. A non-transitory machine-readable storage medium that stores a computer program for operating an inertial sensor unit for a vehicle, the computer program being configured to, when executed:
a) record inertial sensor data and at least one of direction of travel data, steering angle data, and wheel rotational speeds during travel of the vehicle;
b) determine a correction matrix for the inertial sensor data based on at least one of the direction of travel data and the steering angle data;
c) determine a transformation matrix for the inertial sensor data for a target coordinate system based on at least one of the direction of travel data and the steering angle data;
d) determine the inertial sensor data using at least one of the correction matrix and the transformation matrix; and
e) output the transformed inertial sensor data.

9. An electronic control unit for operating an inertial sensor unit for a vehicle, the electronic control unit being configured to:
a) record inertial sensor data and at least one of direction of travel data, steering angle data, and wheel rotational speeds during travel of the vehicle;
b) determine a correction matrix for the inertial sensor data based on at least one of the direction of travel data and the steering angle data;
c) determine a transformation matrix for the inertial sensor data for a target coordinate system based on at least one of the direction of travel data and the steering angle data;
d) determine the inertial sensor data using at least one of the correction matrix and the transformation matrix; and
e) output the transformed inertial sensor data.

10. The electronic control unit as claimed in claim 9, wherein the electronic control unit has at least one non-volatile memory configured to store at least one of the correction matrix, the transformation matrix, and a correction transformation matrix.
